(19) United States
(12) Patent Application Publication
(10) Pub. No.: US 2014/0312152 A1
(43) Pub. Date: Oct. 23, 2014

(54) GRINDER

(71) Applicant: Chung-Jen PAI, New Taipei City (TW)

(72) Inventor: Chung-Jen PAI, New Taipei City (TW)

(21) Appl. No.: 14/251,874

(22) Filed: Apr. 14, 2014

(30) Foreign Application Priority Data
Apr. 19, 2013 (TW) 102207265

(51) Int. Cl. A47J 42/14

(52) U.S. Cl. CPC A47J 42/14
USPC 241/169.1

(57) ABSTRACT

The present invention relates to an improvement for a grinder, which includes a grinder having a top cover; and a rotatable handgrip pivoted with the top cover, the outer side of the rotatable handgrip and the bottom of a holding button are respectively and oppositely formed with an arc-shaped convex part and an arc-shaped concave part, the arc-shaped concave part or the arc-shaped convex part of the holding button is able to be moved along the arc-shaped convex part or the arc-shaped concave part of the rotatable handgrip, the up/down swinging angle generated during the inner side of the rotatable handgrip being rotated is able to be absorbed, thereby enabling the holding button to be constantly vertical to the rotatable handgrip.

### BACKGROUND OF THE INVENTION

1. Field of the Invention:

The present invention relates to a grinder, especially to a grinder having features of manually operated and labor saving.

2. Description of Related Art:

In cooking, spices in a powder shape or particle shape are commonly used, such as pepper powders, sesame powders or coffee powders (hereinafter all referred as spice), the particle-shaped or sheet-like solid member is ground into powders for being easily dissolved and evenly distributed in foods or liquid.

A conventional grinding means is to dispose the particle-shaped or sheet-like spice in a grinder then directly grind manually or electrically the particle-shaped or sheet-like spice into powders such as sesame powders or pepper powders for being added in foods, soup or coffee powders for being brewed. The Taiwan Patent NO.367805 and the Taiwan Patent NO.415215 (corresponding to the U.S. Pat. No. 5,865,384) both granted to the applicant of the present invention have respectively disclosed an electrical grinder and a manual grinder, in which the interior of a hollow housing formed in the grinder is served to accommodate the objects to be ground, e.g. pepper particles, and the top of the housing is provided with a driven device, e.g. an electrically powered device or a manual rotating seat.

Take the Taiwan Patent NO.415215 for example, when the manual grinder is in use, the users holds the housing with one hand, and the other hand holds a rotating seat for the purpose of rotation, so a spindle and a rotating grinding disk relative to a fixed grinding base are driven to rotate, the particle-shaped or sheet-like spice received between the grinding disk and the grinding base is ground by grinding teeth of the grinding base and disk teeth of the grinding disk thereby obtaining powders, then discharged from a base disk of an adjusting device so as to be sprinkled on foods.

The above-mention manual grinder requires a hand to directly hold the rotating seat for the purpose of rotation, because the force arm of the rotating seat is relatively shorter, the labor and time required for operation become relatively greater. As such, the skilled people in the art have developed a design of additionally installing a rotatable handgrip on a coffee bean grinder for driving a spindle and a rotating disk relative to a fixed grinding base to rotate, the installation of the rotatable handgrip allows the force arm at the force applying end to be longer thereby saving labor in operation; however, the rotatable handgrip is formed in a horizontal status which cannot be folded and the length thereof is fixed, in other words the length of the rotatable handgrip cannot be greater than the maximum outer diameter of the coffee bean grinder for preventing the package volume from increasing, but it is well known that the longer the force applying end, the less labor in operation, so how to additionally install a rotatable handgrip on a grinder and having a length greater than the maximum outer diameter of the grinder without increasing the package volume shall be seriously concerned.

### SUMMARY OF THE INVENTION

One primary objective of the present invention is to provide an improvement for a grinder, in which a rotatable handgrip capable of being automatically folded and upwardly lifted is installed, so the length of the rotatable handgrip is allowed to be greater than the maximum outer diameter of the grinder without increasing the package volume, thereby providing advantages of labor saving, time saving and easy operation.

For achieving the objective, the present invention provides an improvement for a grinder, which includes: a grinder, the top thereof is formed with a top cover; and a rotatable handgrip, the inner side thereof is swingably pivoted with the radial periphery of the top cover, the outer side thereof is provided with a holding button, the outer side of the rotatable handgrip and the bottom of the holding button are respectively and oppositely formed with an arc-shaped convex part and an arc-shaped concave part, a pin rod of a shaft pin is allowed to pass a shaft hole formed on the arc-shaped convex part or the arc-shaped concave part and having a diameter greater than the pin rod then be inserted in a pin hole axially formed on the arc-shaped concave part or the arc-shaped convex part of the holding button, so the arc-shaped concave part or the arc-shaped convex part of the holding button is able to be moved along the arc-shaped convex part or the arc-shaped concave part of the rotatable handgrip, the up/down swinging angle generated during the inner side of the rotatable handgrip being rotated is able to be absorbed, thereby enabling the holding button to be constantly vertical to the rotatable handgrip.

### BRIEF DESCRIPTION OF THE DRAWINGS

The present invention will be apparent to those skilled in the art by reading the following detailed description of a preferred embodiment thereof, with reference to the attached drawings, in which:

FIG. 1a is a perspective exploded view illustrating the grinder according to the present invention;

FIG. 1b is a perspective exploded view illustrating the grinder being viewed from another angle according to the present invention;

FIG. 2 is a perspective view illustrating the assembly of the grinder according to the present invention;

FIG. 3 is a cross sectional view illustrating the assembly of the grinder according to the present invention;

FIG. 4 is a perspective exploded view illustrating the grinder and the rotatable handgrip according to the present invention;

FIG. 5 is a perspective view illustrating the rotatable handgrip being operated according to the present invention; and

FIG. 6 is a partial cross sectional view illustrating the rotatable handgrip and the grinder according to the present invention.

### DETAILED DESCRIPTION OF THE PREFERRED EMBODIMENT

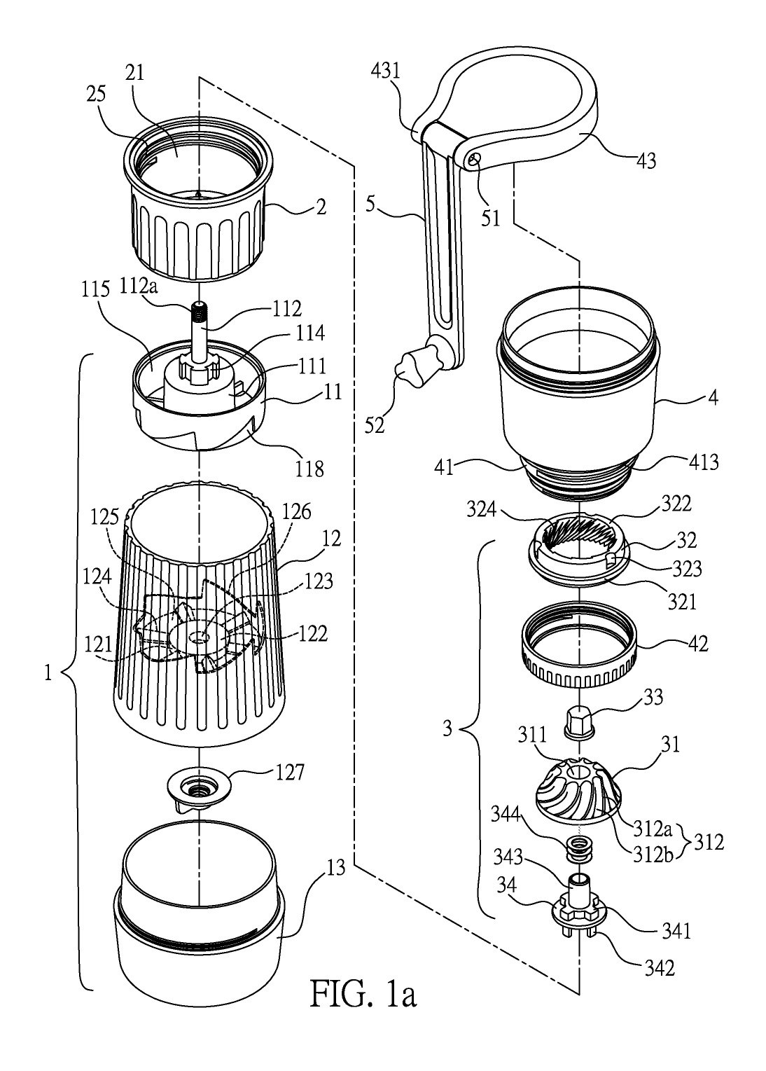

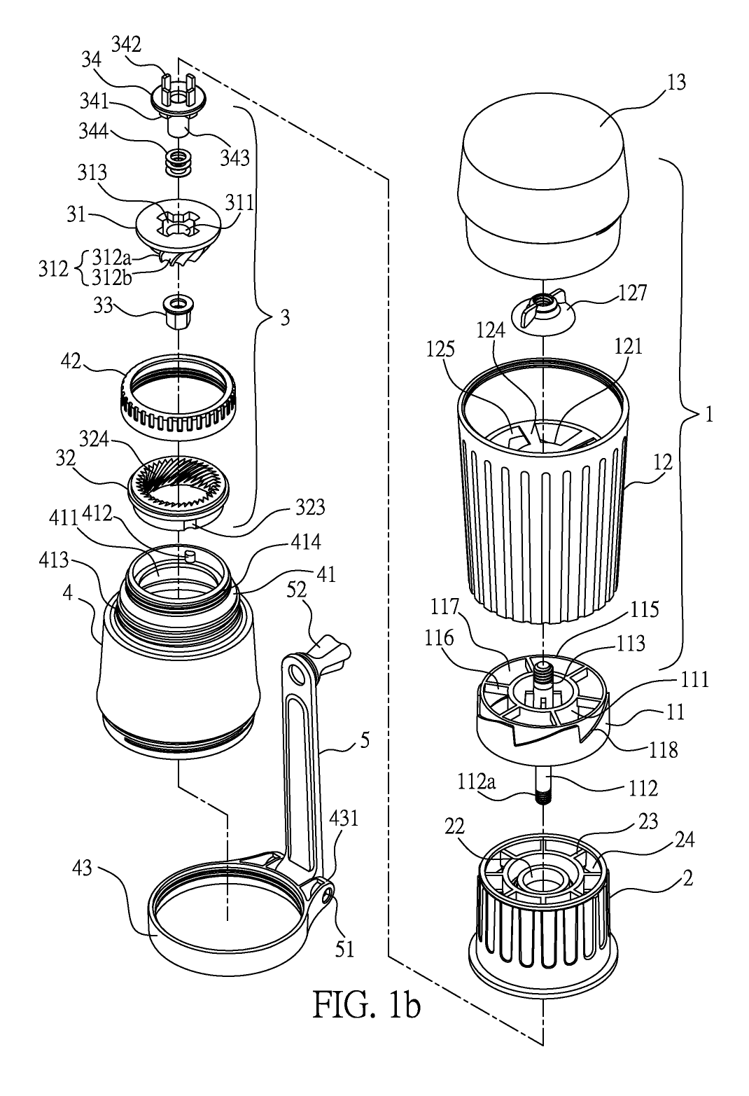

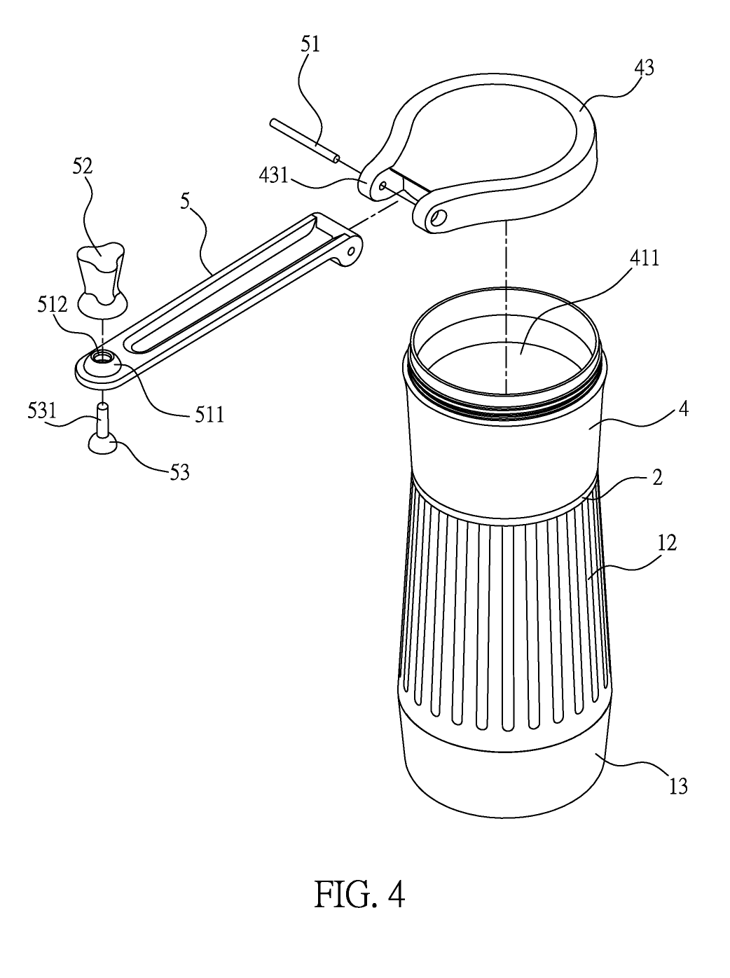

Referring from FIG. 1a to FIG. 6, the present invention provides a grinder, which includes a housing 1, a base 2, a grinding device 3, a container 4 and a rotatable handgrip 5.

As shown from FIG. 1a to FIG. 3, the housing 1 includes a fasten seat 11 and a tubular body 12. The top and the bottom surfaces of a shaft ring 111 at the center of the fasten seat 11 are respectively and longitudinally formed with a fasten shaft 112 and a combination shaft 113, the fasten shaft 112 is sleeved with a grinding disk 31 of the grinding device 3 thereby enabling the above two to be fastened with each other so as to form a fastened state.

The top surface of the shaft ring 111 is formed with a plurality of insertion slots 114 allowing insertion tenons 342 correspondingly formed at the bottom of a connection member 34 of the grinding device 3 to be inserted in the insertion slots 114 after passing a connection ring 22 of the base 2. The shaft ring 111 is connected with an outer ring 115 through a plurality of radially-arranged first connection tenons 116, and a first outlet 117 is formed between every two of the adjacent first connection tenons 116, and the outer wall of the outer ring 115 is annularly formed with a plurality of unidirectional gear slots 118 thereby being able to be sleeved and fastened in the tubular body 12.

The tubular body 12 is sleeved at the lower portion of the base 2 and the container 4. When in use, the user holds the tubular body 12 with one hand, and the other hand holds the rotatable handgrip 5 laterally pivoted with a top cover 43 of the container 4 for the purpose of rotation, so a grinding seat 32 of the grinding device 3 is linked by the container 4 to synchronously rotate.

Wherein, the mid inner wall of the tubular body 12 is formed with a position member 121 allowing the fasten seat 11 to cross, and the center of the position member 121 is formed with a block sheet 122, the block sheet 122 is longitudinally formed with a penetrated hole 123 allowing the combination shaft 113 to pass, and the periphery of the block sheet 122 is respectively formed with a radially-arranged second connection tenon 124 corresponding to each of the first connection tenons 116 and connected to the inner wall of the tubular body 12, and a second outlet 125 communicated with the first outlet 117 is formed between every two of the adjacent second connection tenons 124, thereby allowing ground powders to pass. In addition, the inner wall of the tubular body 12 is annularly and protrudingly formed with unidirectional ratchets 126 corresponding to the unidirectional gear slots 118, and the unidirectional gear slots 118 are able to be mutually sleeved with the unidirectional ratchets 126.

As such, when the fasten seat 11 is disposed in the tubular body 12 and abutted against the position member 121, the combination shaft 113 is allowed to pass the penetrated hole 123 and connected (e.g. screw-fitted) with a combination button 127, and the plurality of the unidirectional gear slots 118 formed on the outer peripheral surface of the fasten seat 11 are sleeved with the unidirectional ratchets 126 correspondingly formed on the inner wall of the tubular body 12, so the fasten seat 11 is able to be fastened in the tubular body 12.

Moreover, a bottom opening of the tubular body 12 can be connected (e.g. screw-fitted) with a powder accommodating cup 13 for accommodating the powders, e.g. coffee powders, ground by the grinding device 3.

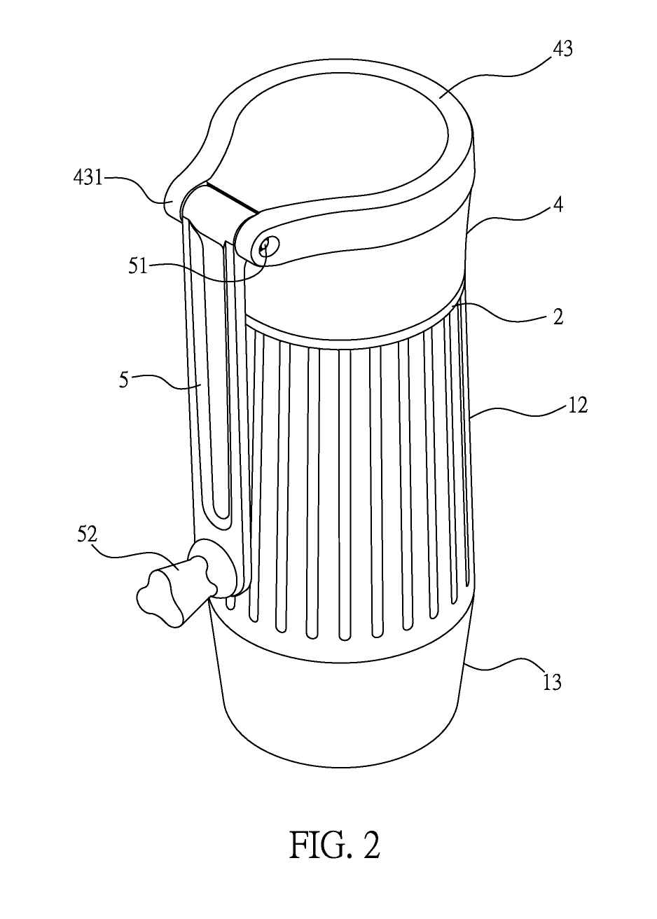

The base 2 is formed as a hollow tubular member, the bottom thereof is sleeved with the top of the fasten seat 11, and the top thereof is connected with the container 4. The base 2 is formed with a hollow grinding chamber 21, the center of the bottom wall thereof allows the fasten shaft 112 to protrude therein. As shown in FIG. 2, for allowing the base 2 and the fasten seat 11 to be combined, the bottom of the grinding chamber 21 is formed with a connection ring 22 for being sleeved with the shaft ring 111 of the fasten seat 11, the periphery of the connection ring 22 is connected with the bottom inner wall of the grinding chamber 21 through a plurality of ribs 23, so the ground powders are allowed to fall through slits 24 formed between the ribs 23 into discharging channels formed through the mutually-stacked first and the second outlets 117, 125 of the housing 1. In addition, the inner top wall of the grinding chamber 21 is formed with at least an inner thread segment 25 thereby being able to be screw-fitted with a first outer thread segment 413 preformed on a sleeve ring 41 at the bottom of the container 4.

The grinding device 3 is composed of a grinding disk 31 and a grinding seat 32, the grinding disk 31 is formed as a conical member and the center thereof is formed with a disk hole 311 allowing the fasten shaft 112 to pass, a thread segment 112a at the upper portion of the fasten shaft 112 is screw-fitted with an end sealing member 33, thereby enabling the grinding disk 31 to be detachably installed on the fasten shaft 112 so the grinding disk 31 is allowed to be processed with a cleaning treatment. Wherein, the periphery of the disk hole 311 is integrally and downwardly extended with a disk teeth 312 formed with a plurality of staggeringly-arranged spiral disk wings 312a and spiral grooves 312b.

For enabling the grinding disk 31 and the fasten shaft 112 to form a fastened status, the bottom surface of the grinding disk 31 is concavely formed with an engaging part 313, e.g. a cross-shaped concave slot, the engaging part 313 is inserted and positioned with an insertion part 341, e.g. a cross-shaped tenon, protrudingly formed on the top surface of the connection member 34, the connection member 34 is allowed to cross the connection ring 22 at the bottom center of the base 2, and the bottom surface thereof is downwardly protruded with a plurality of insertion tenons 342 crossing the connection ring 22, the insertion tenons 342 are inserted in the insertion slots 114 correspondingly formed on the shaft ring 111, thereby enabling the grinding disk 31 to synchronously rotate with the fasten seat 11.

Wherein, for allowing the grinding disk 31 and the connection member 34 to be formed as one piece, the top surface of the connection member 34 is protrudingly formed with a sleeve tube 343 corresponding to the disk hole 311, the sleeve tube 343 is sleeved with at least a pad 344 used for adjusting the gap between the grinding disk 31 and the grinding base 32 then received in the disk hole 311, then the sleeve tube 343 protruded outside the disk hole 311 is processed with a thermal riveting treatment for allowing the grinding disk 31 and the connection member 34 to be formed as one piece, and the fasten shaft 112 is allowed to pass the sleeve tube 343, the thread segment 112a at the upper portion and the end sealing member 33 are screw-fitted, thereby preventing the grinding disk 31 from being axially released.

The grinding seat 32 is formed as a stepped ring member and fasten at the bottom of the container 4, the bottom of the grinding seat 32 is formed with a seat edge 321 having a relatively larger diameter, and the top thereof is formed with a grinding cylinder 322 having a relatively smaller outer dimension, the outer peripheral wall of the grinding cylinder 322 is protrudingly formed with a plurality of positioning recesses 323 thereby being able to be inserted and positioned in the container 4. In addition, the inner peripheral wall of the grinding cylinder 322 is annularly formed with a plurality of oblique grinding teeth 324. As shown in FIG. 2, when the grinding disk 31 is protruded into the grinding cylinder 322, a gap is constantly kept between the above two. When the grinding seat 32 is rotated, the objects to be ground, e.g. coffee beans, are driven by the oblique grinding teeth 324 for being moved along the disk wings 312a and the spiral grooves 312b of the disk teeth 312 and being ground between the disk teeth 312 and the grinding teeth 324, then the ground powders with various sizes are moved along slits formed between the above two, when the size of the ground power is smaller than the slit, the ground powders are allowed to fall from the grinding device 3 and pass the discharging channels formed through the first and the second outlets 117, 125 then fall into the powder accommodating cup 13 for the purpose of temporary storage. When the size of the ground powder is larger than the slit, the powders are remained in the slit for being continuously ground so as to obtain powders with uniform size. Wherein, the grinding disk 31 and the grinding base 32 are made of a precision ceramic having properties of acid and alkaline proof, durable, antioxidant and avoiding inherent change regarding to the objects to be ground. The container 4 is disposed at the top of the base 2, and the container 4 is preferably to be formed as a hollow transparent member for easily observing the amount of objects to be ground. The bottom of the container 4 is extended with a stepped sleeve ring 41 formed with a penetrated hole 411 at the center, the sleeve ring 41 allows the grinding seat 32 to be mounted therein, and the inner peripheral wall thereof is formed with a plurality of positioning ribs 412 corresponding to the positioning recesses 323 thereby being able to be combined, and a combination ring 42 is combined with a second outer thread segment 414 formed at the bottom of the sleeve ring 41 thereby enabling the grinding seat 32 to be stably fastened at the bottom of the sleeve ring 41 and be detachably installed in the sleeve ring 41 at the bottom of the container 4. When the combination ring 42 is removed, the grinding seat 32 is enabled to be processed with a cleaning treatment. Moreover, for sealing the container 4, a top opening thereof is sealed by being combined with a top cover 43.

Referring from FIG. 1 to FIG. 6, the inner side of the rotatable handgrip 5 utilizes an insertion pin 51 for being pivoted with an edge part 431, e.g. a pair of lugs, radially and protrudingly formed on the top cover 43, so the rotatable handgrip 5 is formed in a downwardly-oriented folding status relative to the top cover 43 due to the gravity. The outer side of the rotatable handgrip 5 is provided with a holding button 52, the outer side of the rotatable handgrip 5 and the bottom of the holding button 52 are respectively and oppositely formed with an arc-shaped convex part 511 and an arc-shaped concave part 521, and a pin rod 531 of a shaft pin 53 is utilized for passing a shaft hole 512 axially formed on the arc-shaped convex part 511 and having a diameter larger than the pin rod 531, then being inserted in a pin hole 522 axially formed on the arc-shaped concave part 521 of the holding button 52, thereby enabling the arc-shaped concave part 521 of the holding button 52 to be moved along the arc-shaped convex part 511 of the rotatable handgrip 5, so the up/down swinging angle generated during the inner side of the rotatable handgrip 5 being rotated can be absorbed, the holding button 52 is enabled to be constantly vertical to the rotatable handgrip 5, thereby providing convenience when the user applies external force for operation. As shown in figures, the arc-shaped convex part 511 is formed at the outer side of the rotatable handgrip 5, and the arc-shaped concave part 521 is formed at the bottom of the holding button 52, what shall be addressed is that the present invention is not limited to the above-mentioned arrangement, the arrangement of the arc-shaped convex part 511 being formed at the bottom of the holding button 52 and the arc-shaped concave part 521 being formed at the outer side of the rotatable handgrip 5 shall also be within the scope of the present invention.

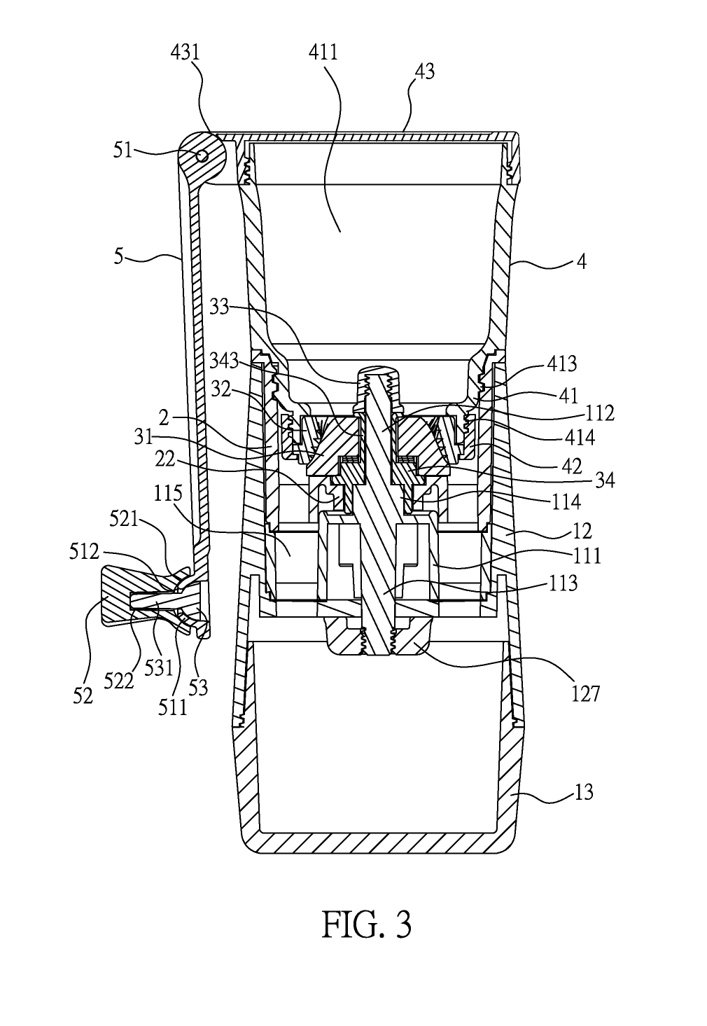

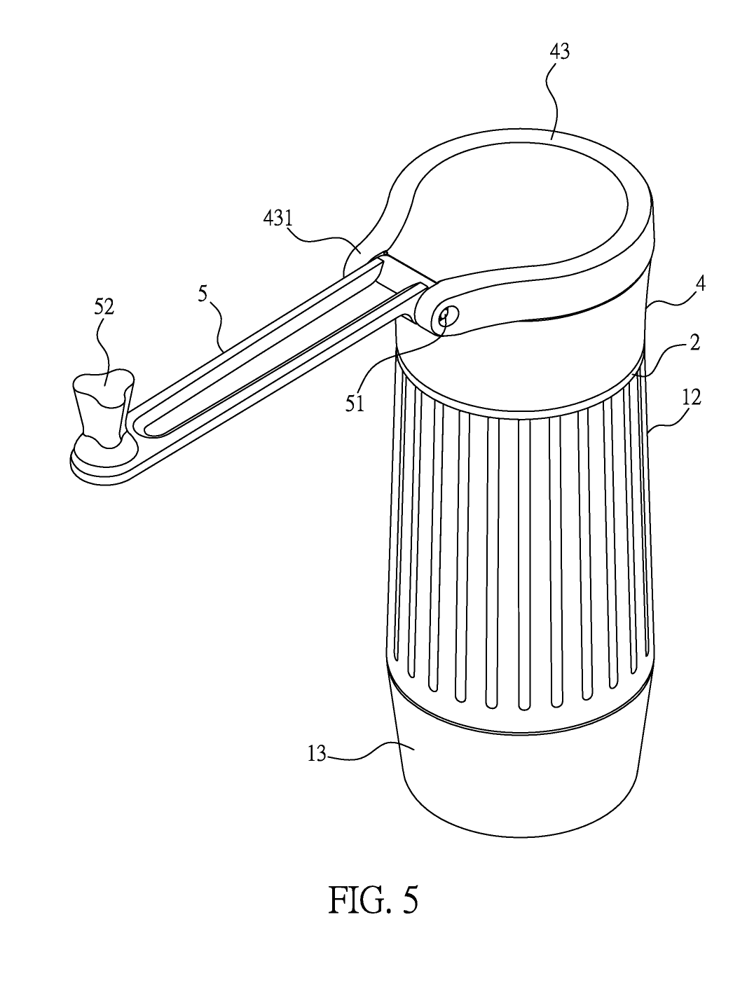

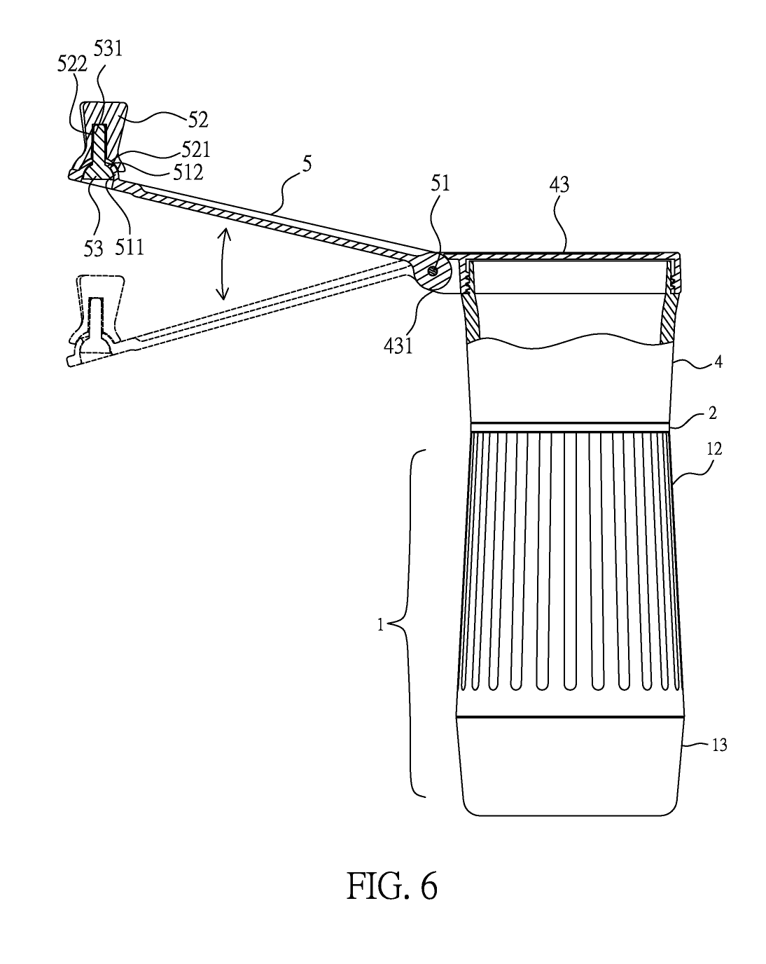

As shown in FIG. 2 and FIG. 3, which are a perspective view and a cross sectional view illustrating the assembly of the grinder according to the present invention. When a grinding operation is desired to be processed, please refer to FIG. 5 and FIG. 6, the user holds the tubular body 12 with one hand, and the other hand holds the holding button 52, so the rotatable handgrip 5 is able to be upwardly lifted for performing a rotating motion, an up/down swinging motion may be generated at the location where the rotatable handgrip 5 and the edge part 431 being connected due to the different magnitude of force applied by the user, so the arc-shaped concave part 521 of the holding button 52 is moved along the arc-shaped convex part 511 of the rotatable handgrip 5 for absorbing the up/down swinging angle generated during the inner side of the rotatable handgrip 5 being rotated, the up/down swinging angle is e.g. but not limited to 15 degrees each, thereby enabling the holding button 52 to be constantly vertical to the rotatable handgrip 5. At this moment, the top cover 43 is able to drive the container 4, the grinding seat 32 and the base 2 to rotate, and the objects to be ground, e.g. coffee beans, accommodated in the container 4 are driven by the oblique grinding teeth 324 of the grinding seat 32 for being moved along the disk wings 312a and the spiral grooves 312b of the disk teeth 312 and ground between the disk teeth 312 and the grinding teeth 324, then the ground powders with various sizes are moved along the slits formed between the grinding disk 31 and the grinding seat 32, then the ground powders with uniform sizes are allowed to fall from the grinding device 3 and pass the discharging channels formed through the first and the second outlets 117, 125 of the fasten seat 11 and the tubular body 12 then fall into the powder accommodating cup 13 for the purpose of temporary storage.

Based on what has been disclosed above, advantages achieved by the present invention are as following: the top cover of the grinder is pivoted with the rotatable handgrip capable of being automatically folded and upwardly lifted, so when the rotatable handgrip is not in use, the rotatable handgrip is formed in a downwardly-oriented folding status due to the gravity, thereby saving the transportation cost without increasing the package volume; moreover, the rotatable handgrip and the holding button are respectively and oppositely formed with the arc-shaped convex part and the arc-shaped concave part, the up/down swinging angle generated during the rotatable handgrip being rotated can be absorbed, thereby enabling the holding button to be constantly vertical to the rotatable handgrip, so convenience is provided when the user applies external force for operation; furthermore, the length of the rotatable handgrip is larger than the maximum outer diameter of the grinder, thereby providing advantages of labor saving, time saving and easy operation. Accordingly, the grinder provided by the present invention is novel and more practical in use comparing to prior art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims.

Although specific terms are employed herein, they are used in a generic and descriptive sense only and not for purposes of limitation.

What is claimed is:

1. An improvement for a grinder, including:
a grinder, the top thereof being formed with a top cover; and
a rotatable handgrip, the inner side thereof being swingably pivoted with the radial periphery of said top cover, the outer side thereof being provided with a holding button, the outer side of said rotatable handgrip and the bottom of said holding button being respectively and oppositely formed with an arc-shaped convex part and an arc-shaped concave part, a pin rod of a shaft pin being allowed to pass a shaft hole formed on said arc-shaped convex part or said arc-shaped concave part and having a diameter greater than said pin rod then be inserted in a pin hole axially formed on said arc-shaped concave part or said arc-shaped convex part of said holding button, so said arc-shaped concave part or said arc-shaped convex part of said holding button being able to be moved along said arc-shaped convex part or said arc-shaped concave part of said rotatable handgrip, the up/down swinging angle generated during the inner side of said rotatable handgrip being rotated being able to be absorbed, thereby enabling said holding button to be constantly vertical to said rotatable handgrip.

2. The improvement for a grinder as claimed in claim 1, wherein the inner side of said rotatable handgrip utilizes an insertion pin for being pivoted with an edge part radially and protrudingly formed on said top cover.

3. The improvement for a grinder as claimed in claim 1, wherein the length of said rotatable handgrip is greater than the maximum outer diameter of said grinder.

4. The improvement for a grinder as claimed in claim 1, wherein said grinder includes a housing, a base, a grinding device and a container; wherein:
said housing includes a fasten seat fastened in a tubular body, the top surface of a shaft ring at the center of said fasten seat is formed with a fasten shaft, at least a first outlet is formed between said shaft ring and an outer ring; the mid inner wall of said tubular body is formed with a position member allowing said fasten seat to cross and be positioned, said position member is formed with a second outlet corresponding to and communicated with said first outlet, so a discharging channel is formed through said first outlet and said second outlet;
said base is formed with a grinding chamber allowing said fasten shaft to be accommodated, the bottom of said grinding chamber is formed with a connection ring sleeved with said shaft ring, and said connection ring is formed with at least a slit corresponding to said discharging channel;
said grinding device includes a grinding disk and a grinding seat, said grinding disk is detachably fastened on said fasten shaft, and said grinding base is fastened at the bottom of said container, wherein said grinding disk is protruded into said grinding seat and a gap is formed between said above two; and
said container is disposed at the top of said base, said top cover is connected with a top opening of said container, and a bottom opening thereof utilizes a sleeve ring to enable said grinding seat to be detachably disposed at the bottom of said container.

5. The improvement for a grinder as claimed in claim 4, wherein said bottom opening of said tubular body is further connected with a powder accommodating cup.

6. The improvement for a grinder as claimed in claim 4, wherein said shaft ring and said outer ring are connected through a plurality of radially-arranged first connection tenons, and said first outlet is formed between every two of said adjacent first connection tenons; the bottom surface of said shaft ring is longitudinally protruded with a combination shaft; and the center of said position member of said tubular body is formed with a block sheet, said block sheet is longitudinally formed with a penetrated hole allowing said combination shaft to pass, and said combination shaft is connected with a combination button; and the periphery of said block sheet is respectively formed with a radially-arranged second connection tenon corresponding to each of said first connection tenons and connected to the inner wall of said tubular body, and said second outlet communicated with said first outlet is formed between every two of said adjacent second connection tenons.

7. The improvement for a grinder as claimed in claim 6, wherein the outer wall of said outer ring is annularly formed with a plurality of unidirectional gear slots, and the inner wall of said tubular body is annularly and protrudingly formed with a plurality of unidirectional ratchets corresponding to said unidirectional gear slots.

8. The improvement for a grinder as claimed in claim 4, wherein the periphery of said connection ring is connected with the bottom inner wall of said grinding chamber through a plurality of ribs, and said slit is formed between every two of said adjacent ribs.

9. The improvement for a grinder as claimed in claim 4, wherein a connection member is further provided between said fasten seat and said grinding disk, said connection member allows said fasten shaft to pass and cross on said connection ring at the bottom of said base, the top surface of said connection member is formed with a mounting part, said mounting part is mounted in an engaging part oppositely formed at the bottom surface of said grinding disk, and the bottom surface of said connection member is protrudingly formed with a plurality of insertion tenons, said insertion tenons are inserted in insertion slots correspondingly formed at the periphery of said connection ring.

10. The improvement for a grinder as claimed in claim 9, wherein the top surface of said connection member is protrudingly formed with a sleeve tube capable of being protruded and exposed outside the top of said grinding disk, the top of said sleeve tube is processed with a thermal riveting treatment for allowing said grinding disk and said connection member to be formed as one piece; and said fasten shaft is allowed to pass said sleeve tube, and a thread segment formed at the upper portion of said fasten shaft is screw-fitted with an end sealing member.

11. The improvement for a grinder as claimed in claim 10, wherein said sleeve tube is sleeved with at least a pad used for adjusting the gap between said grinding disk and said grinding seat.
